(19) United States
(12) Patent Application Publication
(10) Pub. No.: US 2009/0142853 A1
(43) Pub. Date: Jun. 4, 2009

(54) MICROFLUIDIC SYSTEM AND METHODS

(75) Inventors: Brian Herbert Warrington, Essex (GB); Christopher Kevin Hoyle, Essex (GB); Theresa Jane Pell, Essex (GB); David Alan Pardoe, Essex (GB)

Correspondence Address: EKSIGENT TECHNOLOGIES, LLC;c/o SHELDON MAK ROSE & ANDERSON, 100 East Corson Street, Third Floor, PASADENA, CA, 91103-3842, US

(73) Assignee: EKSIGENT TECHNOLOGIES, LLC, Dublin, CA (US)

(21) Appl. No.: 11/719,534

(22) PCT Filed: Aug. 10, 2006
(86) PCT No.: PCT/US06/31162

§ 371 Date: May 16, 2007

Related U.S. Application Data
(60) Provisional application No. 60/707,384, filed on Aug. 11, 2005.

(51) Int. Cl. G01N 21/64

(52) U.S. Cl. 436/172; 422/82.07

(57) ABSTRACT

A microfluidic system comprising: at least one microfluidic channel, the inner surface of which is fluorinated or fluorous; and a pump for supplying a flow of an aqueous medium containing chemical reagents or assay components to said microfluidic channel. Preferably, the apparatus further comprises a supply of a non-aqueous medium which is compatible with the surface of the microfluidic channel but immiscible with the aqueous medium, such as a perfluorocarbon solvent, for forming a sheath around the flowing aqueous medium whereby the aqueous medium is suspended away from the surface of the microfluidic channel. Also provided are methods for carrying out a chemical reaction or a biological assay in the microfluidic systems of the subject matter disclosed herein.

### CROSS-REFERENCE TO RELATED APPLICATIONS

This application claims the benefit of U.S. Patent Application Ser. No. 60/707,384, filed Aug. 11, 2005, the disclosure of which is incorporated herein by reference in its entirety. The disclosures of the following U.S. Provisional Applications, commonly owned and simultaneously filed Aug. 11, 2005, are all incorporated by reference in their entirety: U.S. Provisional Application entitled MICROFLUIDIC APPARATUS AND METHOD FOR SAMPLE PREPARATION AND ANALYSIS, U.S. Provisional Application No. 60/707,373 (Attorney Docket No. 447/99/2/1); U.S. Provisional Application entitled APPARATUS AND METHOD FOR HANDLING FLUIDS AT NANO-SCALE RATES, U.S. Provisional Application No. 60/707,421 (Attorney Docket No. 447/99/2/2); U.S. Provisional Application entitled MICROFLUIDIC BASED APPARATUS AND METHOD FOR THERMAL REGULATION AND NOISE REDUCTION, U.S. Provisional Application No. 60/707,330 (Attorney Docket No. 447/99/2/3); U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4); U.S. Provisional Application entitled METHODS AND APPARATUSES FOR GENERATING A SEAL BETWEEN A CONDUIT AND A RESERVOIR WELL, U.S. Provisional Application No. 60/707,286 (Attorney Docket No. 447/99/2/5); U.S. Provisional Application entitled MICROFLUIDIC SYSTEMS, DEVICES AND METHODS FOR REDUCING DIFFUSION AND COMPLIANCE EFFECTS AT A FLUID MIXING REGION, U.S. Provisional Application No. 60/707,220 (Attorney Docket No. 447/99/3/1); U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2); U.S. Provisional Application entitled MICROFLUIDIC SYSTEMS, DEVICES AND METHODS FOR REDUCING BACKGROUND AUTOFLUORESCENCE AND THE EFFECTS THEREOF, U.S. Provisional Application No. 60/707,386 (Attorney Docket No. 447/99/3/3); U.S. Provisional Application entitled MICROFLUIDIC CHIP APPARATUSES, SYSTEMS, AND METHODS HAVING FLUIDIC AND FIBER OPTIC INTERCONNECTIONS, U.S. Provisional Application No. 60/707,246 (Attorney Docket No. 447/99/4/2); U.S. Provisional Application entitled METHODS FOR CHARACTERIZING BIOLOGICAL MOLECULE MODULATORS, U.S. Provisional Application No. 60/707,328 (Attorney Docket No. 447/99/5/1); U.S. Provisional Application entitled METHODS FOR MEASURING BIOCHEMICAL REACTIONS, U.S. Provisional Application No. 60/707,370 (Attorney Docket No. 447/99/5/2); and U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8); U.S. Provisional Application entitled PLASTIC SURFACES AND APPARATUSES FOR REDUCED ADSORPTION OF SOLUTES AND METHODS OF PREPARING THE SAME, U.S. Provisional Application No. 60/707,288 (Attorney Docket No. 447/99/9); U.S. Provisional Application entitled BIOCHEMICAL ASSAY METHODS, U.S. Provisional Application No. 60/707,374 (Attorney Docket No. 447/99/10); and U.S. Provisional Application entitled FLOW REACTOR METHOD AND APPARATUS, U.S. Provisional Application No. 60/707,233 (Attorney Docket No. 447/99/11).

### TECHNICAL FIELD

The subject matter disclosed herein relates to a microfluidic system and to a method of operating a microfluidic system.

### BACKGROUND ART

In vitro biological assays, such as diagnostic assays play a vital role in pharmaceutical research, the biotechnology industry and the healthcare industry in general. In vitro biological assays are used to assess chemical entity-target interactions and the suitability of chemical entities such as drug molecules.

In such assays, the target is most often a protein, either in isolated form or as part of a more complex system such as whole cells, microsomes, membrane vesicles, blood, tissue, whole organs or whole organisms. Biological targets relevant to the pharmaceutical industry include enzymes, receptors, ion channels, integrins, cytochrome P450s and transporter systems. Human or human-like targets are preferred as these are more relevant to the development of drugs for use in humans.

It is important that biological information about a chemical entity which could potentially be used as a drug molecule be available as early as possible in the drug discovery process. Such information may include its potency, selectivity, toxicity and pharmacokinetics. The sooner this information is available, the sooner a decision can be made as to whether to continue to progress the chemical entity through the drug discovery process. This prevents waste of valuable resources, such as those used in expensive and time consuming in vivo testing, on chemical entities lacking efficacy or drug-like properties.

In the initial stages of the drug discovery process, a large panel of chemical entities are screened using a biological assay to identify chemical entities which are active against a target. The panel may be an entire collection of chemical entities or it may be a smaller panel selected from the entire collection. Active chemical entities are then tested in further biological assays to allow selection of lead chemical entities having improved potency, selectivity and drug-likeness. At the same time, biological assays can be carried out to provide pharmacokinetic information, such as toxicity, membrane permeability, bioavailability and metabolism of the lead chemical entities. Such further testing facilitates the selection of candidate chemical for pre-clinical development.

In all of the assays carried out in the drug development process, the activity of a chemical entity is defined in terms of the concentration of the chemical entity which produces a predetermined effect. The effect may be a desired effect, such as activity, as characterised by the inhibition of an enzyme by a compound, in which case the compound would be termed and inhibitor, or an undesired effect, such as toxicity or non-specific activity. The aim of these assays is to provide a chemical entity which has a high desired effect at a low concentration without producing undesired effects. The lower the concentration at which the chemical entity produces the desired effect, the more potent that chemical entity is.

Chemical entities are generally initially screened using an isolated target (if available). Assays which use an isolated target are very simple and therefore allow the data generated by the assay to be easily interpreted as there are only few or no assay components to interfere with the signal generated by the assay. Assays using an isolated target do not require the chemical entity to be membrane-permeable and it is therefore possible to use high concentrations of the chemical entities. However, isolated target assays do not allow investigations of toxicity to be carried out and they generally provide no information on the effect a chemical entity would have on a living cell. However, isolated target assays are useful for discovering new classes of active compounds.

It is therefore desirable, at some stage of the drug discovery process, to carry out whole cell assays as these provide more information relevant to the in vivo properties of the chemical entities. In particular, whole cell assays allow the collection of information relating to non-specific effects, membrane permeability and toxicity. However, as the cell is a complex system, it is more difficult to collect and interpret the data.

Biological assays may be classified as either binding or functional. Binding assays use an isolated target and a target-specific ligand which competes with the chemical entity to determine the binding affinity of the chemical entity for the target. This type of assay does not indicate whether the chemical entity is a target agonist, partial agonist or antagonist.

Functional assays are performed using either an isolated target or a more complex system, such as cell fractions and whole cells. Binding of a chemical entity to the target elicits a biological response, such as phosphorylation, dephosphorylation, substrate cleavage, up- or down-regulation of a molecular pathway, a change in voltage or a change in cell morphology, which can be measured.

Biological assays may also be classified as separated or homogeneous. Separated biological assays require a reaction product to be separated from the other assay components, such as by filtration, prior to detection and quantitation of the reaction product. The results of separated assays are easier to interpret as there is less interference from other assay and background components, leading to a higher signal-to-noise ratio. Separated assays include: ELISA (enzyme-linked, immunosorbent assays); DELFIA (dissociation enhanced lanthanide fluoroimmuno assay); and radiometric filter-binding, precipitation or filtration assays. Such assays are generally incompatible with systems in which the assay components are present in flow-based systems.

Homogenous assays do not require a separation step. Consequently, due to their simple format, they are highly suitable for use in automated and/or miniaturised flow-based systems and are compatible with a variety of detection techniques. Examples of homogeneous assays are fluorescence-based such as: fluorescence intensity (FLINT); fluorescence polarisation (FP); fluorescence lifetime (FL); fluorescence resonance energy transfer (FRET); time-resolved fluorescence (TRF); 1D- or 2D-fluorescence intensity distribution analysis (FIDA); or FLuorometric Imaging Plate Reader-based (FLIPR™) assays, radiometric Scintillation Proximity Assays (SPA™), FlashPlate™ assays, luminescence assays, such as the Alpha Screen assay, coupled-assays (e.g. for measuring ATP production), chemiluminescence assays (e.g. luciferase-based assays) and absorbance readout assays.

Within the pharmaceutical, biotechnological and healthcare industries, biological assays have traditionally been performed using a standard ‘microtitre’ plate (MTP). Such MTPs typically comprise 96 individual wells and, for high throughput screening, 384 and 1536 wells in the plates are common. In general, efforts to reduce reagent volumes below 10 μL per well have not been successful, particularly in the lead optimisation stage of the drug discovery process, and in consequence many assays are still performed in 96 and 384 well MTPs. Unfortunately, the higher density MTPs produce an increase in the surface area:volume ratio such that incorrect data may be produced due to non-specific sequestration of one or more components (such as the drug target) by the MTP surface. It is the variability in the results achieved from MTPs that has led to alternative methods of performing biological assays being sought.

Microfluidic systems provide a viable alternative to conventional MTP-based assays. The miniaturisation of assays using a microfluidic approach has the potential to greatly reduce the amount of reagents needed to perform assays (typically less than 100 nL is used) and, in conjunction with novel methodology, streamline the process by which assays are conducted.

Microfluidic systems used for biological assays are particularly advantageous as they provide improved control over mass and heat transport, which in turn provides a more accurate control of concentrations and consequently higher quality data. In addition, continuous flow microfluidic systems used for biological assays allow chemical synthesis step(s) to be carried out directly before an assay, thus shortening the time in which biological data for a chemical entity is obtained.

As a result, the use of microfluidic systems has been established in a variety of disciplines, including analytical chemistry, drug discovery, diagnostics, combinatorial synthesis, biological research and biotechnology, and for a variety of biological assay applications in the pharmaceutical biotechnological and healthcare industries. Such systems are particularly important in the drug discovery process where efforts have been made to reduce cost and improve data quantity and timely availability of data. In conjunction with improved data quality, cost-savings may be gained through decreasing assay volumes and streamlining the assay process by improving automation. However, to date, there are no commercial microfluidic systems available that are able to compete with the MTP approach to performing biological assays.

Microfluidic systems can also be utilized as flow reactors for micro-scale chemical synthesis. Flow reactors have distinct advantages over batch reactors in terms of scalability, safety and control of the reaction conditions.

PCT International Patent No. WO 2004/038363 discloses a process for operating a microreactor comprising an etched reaction channel having diameter 0.2 mm or less. The process comprises pumping a water-immiscible solvent (such as a fluorinated oil) through the channel, and injecting spaced reaction plugs of an aqueous reaction mixture into the flow of solvent to form spaced sequential reaction plugs. The reaction plugs have small volumes, typically femtolitres to nanolitres. The reaction plugs have a length to diameter ratio (hereinafter “aspect ratio”) of from 1 to 4 in order to ensure homogeneity of the plugs on the micro scale. A surfactant may optionally be added to reduce the interfacial energy between the reaction mixture and the fluorinated spacer solvent.

The publication Journal of Combinatorial Chemistry, 2005, 7(1), pages 14-20 discloses a microcoil NMR probe for performing NMR on a series of small samples. Plugs containing the samples in a suitable solvent, typically CDCl₃, d₆-DMSO or another NMR compatible solvent, are introduced into a capillary tube of internal diameter 0.1 mm and caused to flow past the NMR probe. The sample plugs are spaced apart by plugs of an inert immiscible solvent. The spacer plugs between the sample plugs and may also contain an embedded wash plug of immiscible organic solvent. Each discrete plug is typically 1 to 10 μL. The flow rate in the transfer line during flow cycles is typically 1 to 20 μL/min. No chemical reactions take place in the plugs.

Microfluidic systems involve the transport of aqueous media through a network of interconnecting channels that typically have micrometer diameters. In order to achieve the transport of aqueous media, a means of pumping is generally required. The two most common methods of pumping aqueous media are: hydrodynamic (pressure) pumping; and electro-osmotic flow. The most common method of pumping aqueous media in microfluidic systems is hydrodynamic (pressure) pumping. The success of hydrodynamic pumping allows flow rates of less than 10 nL per minute to be achieved and is underlined by its widespread use in high performance liquid chromatography (HPLC). Moreover, hydrodynamic pumping is significantly less sensitive to surface chemistry than electro-osmotic flow when used in conjunction with microfluidic systems.

Hydrodynamic pumping produces a parabolic velocity profile, perpendicular to the direction of the flow. Reaction or assay components in the middle of the channel move much faster (approximately twice the average velocity of the flow) than components close to the wall (whose velocity approximates to zero). The parabolic velocity profile typically produces a distribution (termed a Taylor dispersion) of the components longitudinally as the components pass along the channel. However, the effects of the Taylor dispersion are generally considered inconsequential in comparison to the absorption of reaction or assay components to the surface of the channel through which the aqueous assay medium flows. The extent of interaction between the components and the surface of the channel is dependent on the affinity of each component for the channel surface. Greater washing is required for components that exhibit high affinity for the channel surface, in order to remove all traces of the components before running of a second sample can occur. The requirement for washing reduces the throughput of the system, especially when performing biological assays, which can render microfluidic systems uncompetitive with established MTP protocols.

Many chemical entities used as drugs, or in the synthesis of drugs, have molecular weights that range between 300 Da and 800 Da and similar properties in that they are neither very hydrophobic nor very hydrophilic and they are relatively inflexible. Cells and sub-cellular fractions are generally relatively hydrophilic. There is, therefore, a tendency for reaction components and assay components to become adsorbed on to the surfaces of microfluidic channels in which they are assayed. In the case of cells and sub-cellular fractions (e.g. platelets), there is the added complication that adhesion to a surface may cause channel blockage.

Furthermore, in microfluidic systems, the surface area to volume ratio may increase to such an extent that sequestration of a component by a channel surface results in a significant decrease in the concentration of the component in the aqueous medium. As a result, the concentration of a component in the aqueous medium may be reduced significantly compared to the concentration of the component introduced into the system. This may significantly limit the utility of such microfluidic systems synthesis and assay technology.

It is known in flow cytometry that a first medium provides a flowing sheath around a flow of a second medium containing cells to be analysed in the flow cytometer. The sheath of first medium is provided for the purpose of hydrodynamic focussing. Thus, the sheath of the first medium focuses the second medium such that all of the second medium (and therefore all of the cells to be analysed) passes through the detection volume of the flow cytometer. The main role of the sheath flow, however, is the separation of the cells into a stream of single cells such that each cell can be analysed individually. In flow cytometry, the first and second media are water-based and miscible and may be of similar osmolarity. In flow cytometry cells are usually labelled with fluorescent markers and it generally requires less than 10 ms for the label to be stimulated and for it to fluoresce or for the cell to scatter the stimulating radiation. Due to this short detection time and that fact that cells have a low tendency to diffuse into the first medium, the use of two water-based miscible media does not affect the results obtained by flow cytometry.

### SUMMARY

The subject matter disclosed herein addresses the problem of adsorption of reaction components or assay components, particularly small structurally dissimilar molecules (300-800 Da), onto channel surfaces in microfluidic systems. In particular, it is an aim of the subject matter disclosed herein to address the problem of adsorption of chemical entities, targets and other assay components to channel surfaces in microfluidic systems in order to maintain as far as possible the concentration of the assay components in the aqueous medium at the optimum level for the assay.

In a first aspect, the subject matter disclosed herein provides a microfluidic system comprising:at least one microfluidic channel, the inner surface of which is fluorinated or fluorous; and a pump for supplying a flow of an aqueous medium containing chemical reagents or assay components to said microfluidic channel.

In a second aspect, the subject matter disclosed herein provides a microfluidic system comprising: at least one microfluidic channel, the inner surface of which is fluorinated or fluorous: a supply of an aqueous medium containing chemical reagents or assay components to said microfluidic channel; and a supply of a non-aqueous medium, which is compatible with the surface of the microfluidic channel but immiscible with the aqueous medium, to the microfluidic channel for forming a sheath around the flowing aqueous medium whereby the aqueous medium is suspended away from the surface of the microfluidic channel.

In a further aspect, the subject matter disclosed herein provides a method for carrying out a chemical reaction or a biological assay in a microfluidic system which comprises: causing a first medium containing the reagents or the assay components to flow through a microfluidic channel of the microfluidic system; and causing a second medium, which is immiscible with the first medium, to flow through the microfluidic channel so that the second medium forms a sheath around the flowing first medium. Typically, the second medium is compatible with the inner surface of the channel, which typically is fluorinated or fluorous.

The first medium can be an aqueous medium, and the second medium can be a non-aqueous medium, for instance a fluorous medium, conveniently a perfluorous medium.

It has been found that the use of a second medium, compatible with the fluorinated surface and forming a sheath around the first medium has a number of advantages. Since the sheath medium is compatible with the surface, it is immiscible with the first medium and any reagents which are compatible with the first medium are incompatible with the second, sheath medium. Thus, the reagent medium is contained by the sheath and does not come into contact with the surface of the channel. Moreover, the components of the first medium remain in the first medium and do not become adsorbed on the channel surface. Further, as the second, sheath medium is in contact with the channel surface, the first, reagent medium is not slowed down by the channel surface and the tendency for the formation of a Taylor dispersion gradient is reduced. Rather, the flow of the reaction components and assay components is laminar and the components are mixed by diffusion alone. It is thus possible to reduce or eliminate any variations in the concentrations of the components as the first, reagent medium flows through the channel. This leads to a more reliable assay and/or chemical synthesis. Moreover, the sheath reduces or prevents the adsorption of components onto the channel surface and thus reduces or eliminates the need to wash the channel between assays and/or reaction plugs. This can increase the speed at which the assays can be carried out and thus reduces the time needed to collect data from the assay.

The dimensions of the microfluidic channel used in the subject matter disclosed herein are decided by features such as the surface energy between the medium and the surface, and the viscosity of the liquid. In general, such microfluidic channels will have a maximum cross-sectional dimension of from about 1 micrometer to about 1 mm, and a cross-sectional area of from about 1 micrometer to less than about 1 mm² and a length of from about 0.1 to about 1 m. In certain embodiments, the device contains a plurality of channels in fluid communication, such that the various components of the assay or of the chemical reaction may be introduced into separate channels and flow into in a single channel wherein the assay or chemical synthesis reaction takes place.

Advantageously, the channel is located in a microfluidic chip. Such a microfluidic chip may include a plurality of microfluidic channels, each of which has a fluorinated/fluorous surface. Advantageously, the chip face on which the channels are disposed has an overall area of at most about 400 mm².

The use of such a microfluidic chip allows much smaller quantities of assay components or reagents to be used for any particular assay or chemical synthesis reaction and ensures that the various components are mixed at the correct times and is the correct quantities.

In order to be useful in the subject matter disclosed herein, the inner surfaces of the channels are preferentially wetted by the second (non-aqueous) medium. Suitably, the channels are preferentially wetted by fluorous solvent (as defined below) relative to water and common non-fluorinated organic solvents. Preferably, the channel surfaces are fluorinated/fluorous, and preferably they should be perfluorinated/perfluorous. That is to say, the surfaces should be made from, or coated with, a fluorinated/fluorous compound, preferably a perfluorinated/perfluorous compound, more preferably a compound comprising a perfluorocarbon chain of at least 4, preferably at least 8 carbon atoms. The term “perfluorinated” here and elsewhere in the present specification signifies that substantially all C—H bonds have been replaced by C—F bonds. The term “coated with” herein usually implies covalent bonding between the fluorinated/fluorous compound and the surface, or physical coating with a layer of fluoropolymer. It preferably does not encompass temporary surface modification, as for example by a fluorinated surfactant. It will be appreciated that the surfaces of the parts of the microfluidic system which are fluorinated/fluorous, in particular surfaces of the microfluidic channel(s), may be inherently fluorinated/fluorous or may be treated to render them fluorinated/fluorous. For instance, a channel may be produced by etching a hydrophilic substrate. This will produce a channel having a hydrophilic surface. This can be rendered fluorinated/fluorous by treating it with a perfluorinated/perfluorous finish.

Preferably, the surfaces of any other part of the microfluidic system along which one or more components flows are fluorinated/fluorous, and more preferably all such surfaces are fluorinated/fluorous, or otherwise rendered compatible with the sheath solvent. For instance, if the microfluidic system includes tubes, connectors, valves or conduits used to transport components to a microfluidic chip, it is preferred that the surfaces of such tubes, connectors, valves, conduits are also fluorinated/fluorous. Preferably, any valve used in the microfluidic system has a connection port volume of at most 25 nL.

In certain embodiments, the subject matter disclosed herein utilizes a perfluoro polymeric substrate material in which the channel is formed. The perfluoro polymeric material may be polytetrafluoroethylene (PTFE) perfluoroalkoxy (PFA) copolymer. The surface energy between a fluorinated (“fluorous”) solvent and the perfluoro polymer is considerably lower than the surface interaction energy between an aqueous medium and the perfluoro polymer. As a result, the microchannel surface will be ‘wetted’ by the fluorous solvent preferentially to the aqueous medium, thereby reducing or eliminating the interaction of the aqueous medium with the channel surface.

In certain applications, the use of a fluorinated/fluorous channel surface alone will be sufficient to reduce adsorption of compound/protein to an acceptable level without the need to use a dynamic mobile wall of a non-aqueous, e.g. fluorinated solvent.

Accordingly, in a further aspect, the subject matter disclosed herein provides a method for carrying out a chemical reaction or a biological assay in a microfluidic system which comprises: causing an aqueous medium containing the reagents or the assay components to flow through a microfluidic channel of the microfluidic system, wherein the inner surface of said channel is fluorinated/fluorous to reduce adsorption of said reagents or assay components to said surface.

Suitable hydrophilic substrates which can be rendered fluorinated/fluorous include glasses. Glass combines high structural stability with highly reproducible microstructuring and possesses ideal optical properties (e.g. high transmittance whilst maintaining polarisation of light). However, the surface of glass is generally hydrophilic due to the presence of silanol groups on its surface. These silanol groups can interact with the components of aqueous assay media. In particular, proteins with a predominantly hydrophilic surface have an affinity for the surface of glass. Therefore, it is necessary to treat the glass surface with a fluorinated/fluorous finish to render it fluorinated/fluorous. The fluorinated/fluorous finish may be applied by a chemical treatment or by vapour deposition. Suitable fluorinated finishes which can be applied to such hydrophilic glasses include fluorinated silanes, such as a perfluoroalkylsilane, long chain perfluoroalkylsilanes, such as perfluorohexyl or perfluorooctyl silanes, or mono- and di-chlorinated silanes, such as 1H, 1H, 2H, 2H-pefluorodecyldichloromethylsilane. The perfluoroalkylsilanes preferably used in the subject matter disclosed herein may be (1H, 1H, 2H, 2H-perfluoro-n-hexyl)dimethylchlorosilane, 1H, 1H, 2H, 2H-perfluorooctyldimethylchlorosilane, 1H, 1H, 2H, 2H-perfluorodecyl-dimethylchlorosilane, (1H, 1H, 2H, 2H-perfluoro-n-hexyl)methyidichlorosilane, 1H, 1H, 2H, 2H-perfluorooctylmethyldichlorosilane, 1H, 1H, 2H, 2H-perfluorodecyl-methyldichlorosilane, 1H, 1H, 2H, 2H-perfluorooctyltrichlorosilane, (1H, 1H, 2H, 2H-perfluoro-n-hexyl)trichlorosilane, 1H, 1H, 2H, 2H-perfluorodecyltrichlorosilane. In this instance, the reaction is self-limiting, which produces a homogenous pseudomonolayer of perfluoroalkyl substituents. The homogeneous thin surface allows the maintenance of the polarisation of light and, as a result, the system may be used for detection by fluorescence polarisation, which is a commonly used detection technique for performing biological assays.

From a chemical perspective, surface properties comparable to that produced by reaction of perfluorochlorosilanes with glass may also be produced by physical adsorption followed by baking and/or drying of a dispersion of a fluoropolymer in a suitable solvent, such as CYTOP (Registered Trade Mark, Asahi Glass Corporation). In this instance, however, the layer may not be a monolayer but will be amorphous layer with sub-micron thickness and should, therefore, maintain the polarisation of light.

Channels for the microfluidic system may be manufactured in a number of ways. For instance, a channel may be manufactured: in a glass substrate by photolithography and wet etching; in a silicon substrate by deep reactive ion etching; in a polymer by laser ablation; in a polymer by imprinting, such as by hot-embossing; or in an polymer, such as polydimethylsiloxane, by soft lithography.

The microchannel of the subject matter disclosed herein is typically formed in a single chip that is typically between 1 mm and 2 mm thick. Channels are typically located within 700 μm of the bottom of the material. Inlet tubing is typically connected at the top of the device. Aqueous medium containing assay components, in combination with the non-aqueous medium are introduced into the microfluidic channel via connections such that the centre of the tubing and the centre of the microchannel at the inlets are co-centric. This alignment minimises the disruption of flow, particularly at the interface between the media. The channel may be formed in the surface of one chip substrate, to which surface is applied another substrate on which no channel has been formed. Alternatively, a channel may be formed partly in one substrate and partly in another substrate such that, when one substrate is applied to the other in face-to-face relationship, the complete channel is formed. The two substrates may be held together by fusion or adhesion. Preferably, the two substrates are fabricated from the same material to ensure homogeneity of the channel.

In the case of other parts of the microfluidic system according to the subject matter disclosed herein, the part may for example be formed by etching, moulding, extrusion or machining.

The principal properties required of the sheath-forming medium are:
1. low affinity for chemical reagents and /or assay components;
2. low interfacial energy with the surface of the channel; and
3. immiscibility with the bulk solvent constituent of the reaction medium.
   The formation of a single sheath layer is determined principally by the interfacial properties of the solvents and microchannel, the relatively large surface area:volume ratio and the total flow-rate. The stability of the interface between the sheath medium and the channel surface is maintained because the interfacial energy between the channel surface and the sheath medium is far lower (i.e. more negative interfacial free energy) than the interfacial energy between the reaction medium and the channel surface. The interfacial energy at the interface of the sheath medium and the reaction medium is lower than the interfacial energy between the reaction medium and the channel surface. It is, however, greater than the interfacial energy between the reaction medium and the channel surface. If the above criteria are maintained, then the assay components will neither diffuse to not interact with the channel surface. The flow-rate and the channel dimensions are optimised to provide a single stable sheath flow layer with minimal variation in the diameter of the reaction medium. A stable sheath flow can also be promoted by addition of detergents commonly used for biological assays (e.g. non-ionic detergents such as Tween 80).

One suitably class of sheath media comprises, or consists essentially of, fluorinated or perfluorinated solvents, in particular flourous solvents. The term “fluorous” is an analog to aqueous and denotes highly fluorinated alkane or ether solvents. These commonly give bilayers with organic solvents. As such, fluorous media represent an underutilized “orthogonal phase” that is immiscible in both water and common organic solvents, and is therefore useful for synthesis and separations. Further, many solvent combinations with fluorous solvents become miscible at elevated temperatures. This allows chemistry under homogeneous one phase or heterogeneous two phase conditions. Products may be isolated from the organic layer, and appropriately designed reagents or catalysts remain in the fluorous layer. Fluorous solvents are particularly advantageous as the vast majority of chemical entities do not exhibit a tendency to dissolve in or partition into them. Fluorous solvents include, but are not limited to, perfluorodecalin, perfluoro (methyidecalin), perfluorohydrofluorene or perfluoro-1,3-dimethylcyclohexane.

The immiscibility of fluorous solvents with aqueous media is due to the low polarisability, high ionisation potential and high electronegativity of fluorine. These characteristics give rise to weak intermolecular (Van der Waals) forces that result in the low boiling points typically associated with fluorous solvents.

Fluorous (e.g. Perfluorocarbon) solvents typically possess high densities (2.5 times those of hydrocarbon analogues), have low dielectric constants and a lower polarity than saturated alkanes. This is due to the low surface potential and the compact electron distribution of these fluorocarbon solvents.

Carbon atoms form very strong bonds to fluorine and, as a result, fluorocarbon solvents are highly inert, both thermally and chemically, making them generally non-toxic. The low toxicity of fluorous solvents also makes them eminently useful with biological media and reagents. They are, therefore, ideal for forming a sheath around an aqueous medium, thus preventing the components of the aqueous medium from coming into contact with a channel surface.

The choice of non-aqueous medium will be based in part on the differential viscosity between the non-aqueous medium and aqueous medium, since the surface in all cases will be the same independent of the choice of non-aqueous medium. Viscosity of the non-aqueous medium (for instance, perfluorohydroflurene is 4.84 mm²/s, perfluoro(methyidecalin) is 3.25 mm²/s, perfluorodecalin is 2.66 mm²/s and perfluoro-1,3-dimethylcyclohexane is 1.919 mm²/s) used for the sheath layer and viscosity of the aqueous medium will affect the thickness of the sheath layer, which is typically less than 10 mm. Therefore, the width and velocity of the non-aqueous medium may be controlled by the type of non-aqueous medium used. The lower the viscosity of the non-aqueous medium, the thinner and faster moving the sheath will be. Additionally, the length of the analysis bubble will be dependent on the relative flow rates of the aqueous medium flow and the non-aqueous medium flow. Typically, the length of the aqueous “bubble” will be greater than ten-fold the width of the microchannel and may be greater than one hundred-fold the width of the microchannel, and for example at least 500 fold or at least about 1000 fold the maximum cross sectional dimension (e.g. diameter) of the microchannel, but is not limited to these dimensions. The linear velocity of the flow will typically be between 0.134 m s⁻¹ and 2.08×10⁻⁴ m s⁻¹.

Preferably, a detector is associated with the channel such that readings can be taken while the aqueous medium is in the channel. It is therefore preferred that the material in which the channel is formed is transparent or translucent at least in the region of the detector to permit optical detectors to be used. Preferably, the channel is long enough such that the system can be used for time-based kinetic studies. There may be one or more detection windows that are monitored by the detector at several specific points along the microchannel. Movement of the microchannel in two dimensions (x and y axes) relative to the detector allows time-based measurements for kinetic studies. In addition, movement of the microchannel or, more commonly, movement of the detector allows the vertical (z-axis) adjustment of the detection window(s) relative to the microchannel to ensure that the focal point is centred in the microchannel.

Measurements of the optical properties of chemical entities in the aqueous medium by means of the detector are commonly used to provide a qualitative or quantitative measure of the components within the medium. For biological assays, quantitation of components within the aqueous medium is most commonly achieved on the basis of fluorescence intensity of these components. The subject matter disclosed herein may be used in conjunction with a variety of detection methods, including techniques relating to fluorescence intensity (Fl), time-resolved fluorescence (TIRF), fluorescence lifetime (FL), fluorescence polarization (FP), luminescence, Raman spectroscopy, mass spectrometry and electrophoresis. These detection methods may be used to determine the target activity on the basis of enzyme activity or ligand binding. Fl, TIRF and FP may be used to measure the concentration of a fluorophore product of an enzyme reaction. FL or FP may be used to determine the displacement of fluorescently-labelled ligands by the inhibitor/activator.

An Fl measurement system involves excitation of a fluorophore by a laser. This may be a diode pumped solid state laser. Any excitation wavelength may, in theory, be used although the excitation wavelength chosen will depend on the fluorophore. An excitation wavelength of 532 nm may be used when the fluorophore is Cy3B, for instance.

Detection may be by a confocal optical head. Detection may occur at any emission wavelength and, again, the emission wavelength will depend on the fluorophore. In this example, an excitation wavelength of 488 nm and an emission wavelength of 530 nm may be used when the fluorophore is fluorescein. The detector may comprise a photomultiplier tube (PMT). The data may be acquired from the PMT by any suitable means. In the case of an analogue PMT, the data are acquired using an analogue data acquisition card such as the PCI-6115S card [National Instruments] controlled by suitable software. Any number of data samples per second may be used. Preferably, this number varies between an average of 10 and 100 samples per 10-100 ms sample time. Preferably an average rate of 100 samples per 50 ms is used. The laser and the PMT may be coupled to the optical head using optical fibres.

At least one fluorometric detector may be used. At least one backscatter detector may also be used. In one embodiment, two fluorometric detectors are used in conjunction with a backscatter detector to facilitate the measurement of two fluorophores with distinct spectral characteristics.

Within embodiments of the subject matter disclosed herein, the non-aqueous medium and the aqueous medium are interrogated using fluorescence and back-scattered light. The signal:noise ratio of fluorescence intensity and back-scattered light can be further enhanced using a confocal configuration in which the peak width at half height of incident light intensity for the focal volume is ¼-¾ the depth of the channel. Additionally, the three channels of detection (two fluorescence and one back-scatter) may be acquired simultaneously using an embedded and fixed filter and pin-hole system such as that provided in WO031048744 (Genapta Ltd).

In the subject matter disclosed herein, the different media may be discriminated on the basis of their different refractive indices. This discrimination can be achieved by utilising the change in back-scattered light (BSL) that is associated with the passage of two different phases past a detection point. In a preferred embodiment, the non-aqueous medium is a fluorous solvent such as perfluorodecalin and the change in signal due to BSL is inversely related to the change in the emitted fluorescence light (EFL). BSL is lower in the presence of an aqueous medium relative to the intervening fluorous solvent, which acts as an interstitium between successive bubbles of aqueous medium.

Where the aqueous medium is encapsulated completely (i.e. “bubbles” of aqueous medium are formed), fluorescence data acquisition from the assay components need to be stopped between subsequent bubbles of aqueous medium. In such an instance, the change in BSL may be used to ‘gate’ the initiation and termination of acquisition of EFL data from the bubbles of aqueous medium. As such, acquisition of fluorescence data from the aqueous medium should be unaffected by the length of the bubble. Therefore, the sizes of the bubbles of aqueous medium do not need to be consistent as the change in BSL may be used to ‘gate’ data acquisition of EFL specific to the aqueous medium.

In a preferred embodiment of the subject matter disclosed herein, the microchannel is fabricated from glass due to its homogeneity and low back-scatter level. Using a confocal optical system, the different refractive indices between glass and air and glass and liquid allow the focal point to be positioned within the centre at a specific point along the microchannel by using the change in BSL that occurs as the focal point of detection passes from one medium to another.

In addition, or as an alternative, to using BSL, a second fluorescence channel may be used in conjunction with a ‘tracer’ fluorophore to detect the presence of “bubbles” of aqueous medium. In this embodiment, two fluorophores are used, one as the principal component of detection and the second as the tracer. The two fluorophores should have distinct fluorescence properties enabling them to be distinguished from each other.

Alternative detection modalities that may be used in the subject matter disclosed herein include NMR, Raman spectroscopy, absorbance analysis, colorimetric analysis and mass spectrometry. In one embodiment of the subject matter disclosed herein, when using spectrometry as a detection method, the use of fluorous solvent, such as perfluorodecalin, perfluorohydroflurene, perfluoro(methyidecalin) and perfluoro-1,3-dimethylcyclohexane, is particularly advantageous due to its very low ionisation potential and low vapour pressure. More specifically, when used in conjunction with electrospray ionisation mass spectrometry this would produce selective and sensitive analysis of the aqueous medium.

In another embodiment of the subject matter disclosed herein, Raman spectroscopy may be used in conjunction with nanoparticles (e.g. of gold) (often called surface-enhanced Raman spectroscopy) to quantify bound protein or other chemical entities.

It will be appreciated that it is an advantage of the subject matter disclosed herein that the detector can provide real-time monitoring of the progress of a chemical reaction or assay taking place in the microchannel.

Advantageously, the microfluidic system includes a temperature control element for maintaining the assay components or chemical reagents at a stable temperature throughout the length of the microchannel. Preferably, the temperature control element comprises a heating/cooling block in thermal contact with the microfluidic chip.

As already noted, the systems of the subject matter disclosed herein suitably comprise a supply for providing a flow of one or more of the said media to the channel. The supply may comprise reservoirs for the one or more media, and suitable inlet channels and valves.

Advantageously, the supply element of the microfluidic system includes one or more pumps which maintain the desired volumetric flow rates of the media. Preferably, the pumps maintain stable flow rates, and preferably it is pulse-free flow. The pumps can pump reagents at a constant flow rate. Alternatively, the flow-rate of individual reagents can be adjusted. Typically, the total flow-rate provided by the sum of flow-rates of the pumps remains constant. Preferably, the flow rate in each channel is at most about 2 μL/min. The concentration of reagents within the microchannel device can be altered by adjusting the flow-rate of the appropriate pumps whilst maintaining a constant total volumetric flow-rate of the aqueous components. The concentration range of a single reagent is typically between 40:1 and 100:1. The media of the subject matter disclosed herein should suitably be pumped by hydrodynamic pumping such that the pressure and medium flow are ‘pulse-free’ down to. 1 nL/min. This ensures that the concentration of assay components is predictable from the volumetric flow-rate at any given time at the point of detection. In addition, to ensure accurate flow, the pumping mechanism should be feedback controlled such that the flow is measured and the resultant measurement is used indirectly to control the pressure applied. In the preferred embodiment the pressure applied to drive the liquid will be controlled via a feeback control system in which the volumetric flow-rate is measured downstream of the application of pressure and this measurement is used to regulated the pressure applied that drives the flow. Feedback control of the flow ensures that: non-user-defined changes in volumetric flow due to transient blockages are minimised; rapid changes in flow-rate can be facilitated; and these rapid changes in flow-rate are complemented by rapid changes in the concentration of components. Rapid feedback control facilitates rapid compensation for changes in back-pressure that are associated with changes in fluid viscosity. In. addition, since the flow-rate is measured continually or at intervals of between about 100 ms and about 1 s, the measured flow-rate enables a ‘real’ measure of concentration of components in the assay and not an assumed concentration that is based on assumed flow that is in turn based on the pressure applied to a pumping system that does not have flow-rate feedback control.

A commercially available pumping system (Eksigent Technologies) fulfils the specifications described above.

In certain embodiments, the microfluidic system is adapted to provide a constant flow of the non-aqueous medium into which is introduced discrete aliquots of aqueous medium so that, if desired, different quantities of one or more of the assay components may be present in different aliquots of the aqueous medium. For instance, successive aliquots of the aqueous medium may be identical except that the concentration of a chemical entity being assayed is varied according to a predetermined program. In this way, a dose-response curve for the chemical entity can be generated from the assay data.

It will be appreciated that the composition of the aqueous phase does not need to be homogeneous along the length of the column/bubble. Multiple discrete reactions/syntheses/assays/analyses may take place within a single bubble. For example, discrete spaced-apart plugs of reagents may be introduced into the continuous flow of aqueous medium that forms the bubble. This process may be repeated in follow-on bubbles.

Preferably, the system is arranged such that the sheath of non-aqueous medium is maintained around the aqueous medium over a distance of at least 100 mm and for a time of at least 10 seconds. Preferably, the aqueous medium is in the form of a continous column, or an elongated “bubble” bounded by plugs of the non-aqueous solvent. In the latter case, the aspect ratio of the bubble (i.e. the ratio of its length to its mean diameter) is at least about 10, preferably at least about 100, and more preferably at least about 1000. Suitably, the thickness of the sheath (measured radially from the center of the channel) is from about 100 nm to about 4 μm, for example from about 0.5 μm to about 2 μm.

Use of a sheath of non-aqueous medium around an aqueous medium in a channel in a microfluidic system assists in preventing assay components or other reagents in the aqueous medium from diffusing into the non-aqueous medium and becoming adsorbed onto the channel surface. It also assists in preventing the occurrence of a Taylor dispersion in the aqueous medium and maintaining laminar flow. In this way, the conditions of an assay or other reaction can be more closely controlled and washing steps in the assay procedure can be reduced, thus enabling data to be obtained with less noise and more quickly from the assay.

The use of a fluorous sheath solvent is especially advantageous since such solvents are ‘orthogonal’ to lipophilic solutes (dissolve in octonal) and hydrophilic solutes (dissolved in water). Only those solutes with a perfluorinated moiety might be expected to transfer into the sheath. The occurrence of perfluorinated moieties in drug-like materials is extremely rare. Thus this technology is superior to hydrophilic or hydrophobic treatments, as what kind of treatment is required would need to be determined beforehand depending on the type of molecule to be assayed. For an array of compounds derived by high throughput technology, where a likely design parameter would be a hydrophilic to hydrophobic gradation across the array, it is unlikely that an uninterrupted screening run could be performed. However, a fluorous coating or sheath would be repellent to both hydrophillic and hydrophobic compounds.

The subject matter disclosed herein can control sample handling, data acquisition and data processing via a computer.

Uses for the subject matter disclosed herein include:
1. Measurement of the interaction of small molecule chemical entities with the drug target.
2. Steady-state kinetic measurements.
3. Time-controlled interactions.
4. Non-equilibrium fast kinetics.
5. Protein analysis including quantitation of absolute amount, detection of specific protein.
6. Protein identification of low copy number proteins by enzyme or chemical fragmentation prior to LC-MS.
7. Quantitative and qualitative analysis of chemical entities, e.g. homogeneous immunoassay such as fluorescence polarisation immunoassay (FPIA).
8. Analysis of cell or sub-cellular components, e.g. platelets in the absence of possible interactions with a solid surface.
9. Chemical synthesis, in particular synthesis of particulates such as nanoparticles in which interaction of the nanoparticles with the surface is deleterious to the formation of high quality nanoparticles with high reproducibility and low polydispersity e.g. drug formulation and quantum dots.

As already noted, the systems and methods of the subject matter disclosed herein are especially suitable for performing biological assays. Preferably, the assay is a biological assay, advantageously a homogeneous biological assay. Typical assays used in the subject matter disclosed herein comprise the following reagents that make up the aqueous medium.
1. biological components (proteins, nucleic acid, membrane vesicles, cells, etc.);
2. a labelled ligand or substrate (which acts as the principal component of detection);
3. a buffer; and
4. a chemical entity, such as a drug-like compound or macromolecule (which acts as the principal component of analysis).

The assay components may include, depending on the particular assay, buffering agents, detergents, proteins, peptides, membrane vesicles, labelled ligands, substrates, which may also be labelled, enzymes and chemical entities, such as pharmaceutical drug-like molecules. Preferably, the assay is adapted to generate a fluorescence or luminescence signal.

It will be appreciated that any alternative or preferred feature that has been described above in relation to any one aspect of the subject matter disclosed herein is likewise an alternative or preferred feature applicable to any other aspect of the subject matter disclosed herein as defined herein.

### BRIEF DESCRIPTION OF THE DRAWINGS

The subject matter disclosed herein will now described in more detail, but without in any way limiting the scope of the subject matter disclosed herein as defined in the accompanying claims, with reference to the accompanying drawings, in which:

FIGS. 1a and 1b illustrate profiles of adsorption of three different compounds (FIG. 1a) and desorption of the same compounds (FIG. 1b) from a channel surface upstream of the point of detection or compound quantitation;

FIGS. 2a and 2b illustrate schematic longitudinal and cross-sectional views through a microchannel in the systems of the subject matter disclosed herein, showing a sheath of a non-aqueous medium surrounding an aqueous medium and separating the aqueous medium from a fluorinated inner surface;

FOGS. 3(a), 3(b), and 3(c) show schematic longitudinal and cross-sectional views through a microchannel in the systems of the subject matter disclosed herein, showing a sheath of a non-aqueous medium surrounding an aqueous medium (FIGS. 3(b) and 3(c)), and a reference system without the said sheath (FIG. 3(a));

FIG. 4 is a reaction scheme for the chemical reaction between a perfluoroalkylsilane and a silanol group (SiOH) on a glass surface;

FIGS. 5a and 5b are photomicrographs of a perfluoroalkylsilane-treated glass channel containing perfluorodecalin as a non-aqueous medium and fluorescein in an aqueous medium;

FIG. 5c is a photomicrograph of a glass microchannel having an inner surface treated with a fluoropolymer coating, and containing perfluorodecalin as a non-aqueous medium and fluorescein in an aqueous medium;

FIGS. 6a and 6b are photomicrographs of an untreated glass microchannel containing perfluorodecalin and fluorescein in an aqueous medium;

FIGS. 7a and 7b show schematic plan views of two exemplary designs of microfluidic-devices according to the subject matter disclosed herein;

FIG. 8 is a block diagram showing how the parts of the microfluidic system of FIG. 7 may be linked, controlled and data processed;

FIG. 9 is a graph showing both measured back-scattered light intensity (BSL) and emitted fluorescence light (EFL) intensity against time for an assay in accordance with the subject matter disclosed herein;

FIG. 10 is a graph showing the rapid measured change in EFL from EFLₘₐₓ to EFLₘᵢₙ due to the addition of a chemical entity Cᵢₙ and the rapid change in EFL from EFLₘᵢₙ to EFLₘₐₓ due to rapid removal of the chemical entity in a system according to the subject matter disclosed herein; and

FIG. 11 shows a perspective view of a bespoke microchannel device holder for use in a system according to the subject matter disclosed herein.

### DETAILED DESCRIPTION

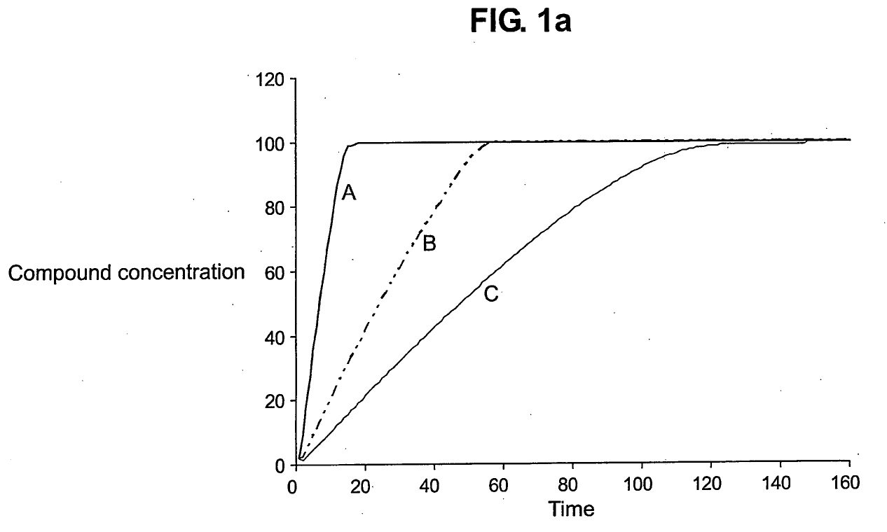

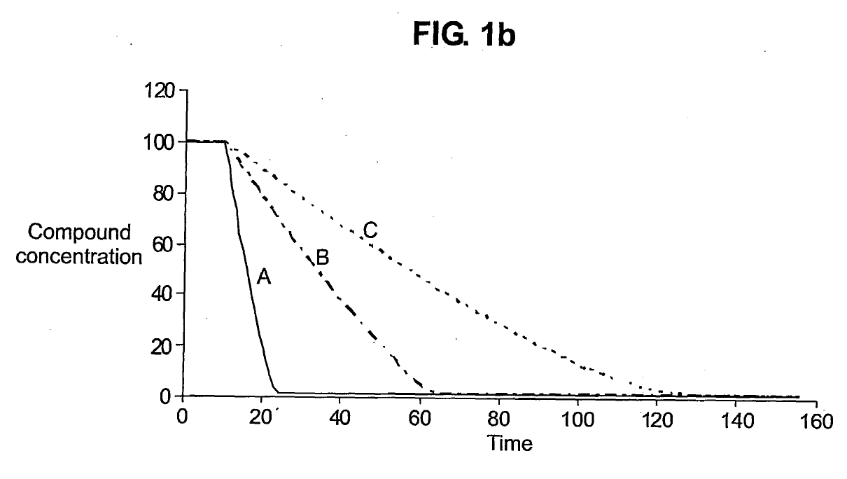

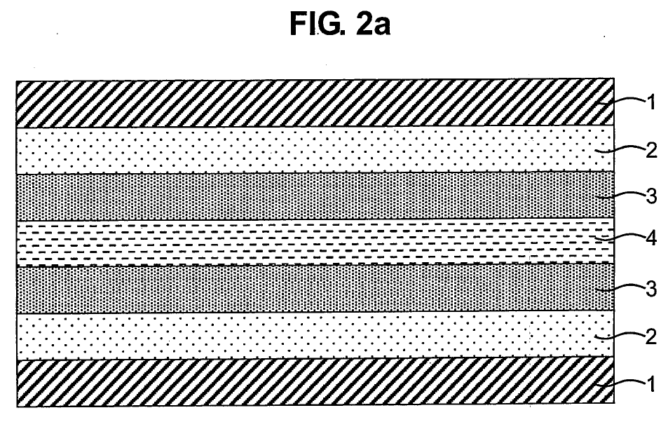

Referring to FIGS. 1a and 1b, the effect of adsorption, with respect to detection of the amount of a component at a specific position within the fluidic channel is shown for three components having different adsorption properties. Pressure-based hydrodynamic pumping, such as that produced by displacement of liquid from a syringe into a microfluidic channel, will produce a flow profile that is laminar and parabolic (in a direction perpendicular to the direction of bulk fluid flow) if the Reynolds number is within the appropriate range which is generally from 400 to 2000. The fastest flow occurs in the middle of the channel, whilst the slowest lies adjacent to the surface of the channel where the flow is assumed to be stationary. Components in this stationary layer are able to adsorb on to the channel surface with far greater frequency than the components in layers nearer the middle of the channel. Adsorption of components to the channel surface is dependent on the affinity of the component for the channel surface and the rate of diffusion from the stationary layer into the bulk flow.

When a component is pumped into the microfluidic device, as in FIG. 1a, the rate of change in the amount of component detected downstream from the point where the component is introduced into the system will be strongly influenced by the interaction of the component with the surface.

In the case of a component that exhibits low adsorption to the channel surface (Curve A in FIGS. 1(a) and 1(b)), the change in the signal, due to the presence of component, is rapid and the Taylor dispersion is the limiting factor that influences this rate of change. In the case of a component that exhibits high adsorption to the surface (Curve C in FIGS. 1(a) and 1(b)), the change in the signal, due to presence of the component, is much slower. In fact, the concentration of the component at the point of detection will only be similar to the concentration of the component that was introduced into the system when the surface upstream of the point of detection is either saturated or has reached equilibrium. In the case of a component that exhibits an intermediate adsorption (Curve B in FIGS. 1(a) and 1(b)), the rate of change in the signal is intermediate the other curves. In the instance where the change in concentration of the component is continuous (e.g. a linear gradient), the concentration gradient of the component will not reflect the corresponding linear change in flow due to adsorption of the component to the surface.

When the component is removed from the microfluidic channel by hydrodynamic pumping, as illustrated in FIG. 1b, the low-adsorption component will be removed rapidly and the intermediate-adsorption component will be removed more slowly. The high-adsorption component will be removed very slowly due to slow desorption of the component from the channel surface at an area upstream from the point of detection. Therefore, it may be difficult to remove all of the high-adsorption component from the microfluidic system.

In the case of a biological assay, the effect of adsorption to the surface of the assay components (e.g. buffering agents, detergent, protein, peptide, membrane vesicles, labelled ligand, substrate, chemical entity, etc.) and the influence of these components on each other must be considered. If a chemical entity is active at a concentration of less than 1 nM and, for instance, this chemical entity was introduced into the microfluidic system at a concentration of 100 μM, due to adsorption that may occur, it may take a long time to remove all the traces of said chemical entity from the microfluidic system. Consequently, the time it takes to analyse other, or different, chemical entities would be increased and the throughput of the system would be decreased considerably.

The subject matter disclosed herein utilizes an alternative to simply pumping an aqueous medium through a microfluidic channel. It comprises pumping two media simultaneously through a fluorinated/fluorous channel. The first medium is a non-aqueous medium that wets the channel wall, and the second is an aqueous medium. The first medium acts to coat the surface of the channel and effectively forms a sheath around the second medium. As a result, the second medium does not contact the channel surface, thus preventing the formation of a stationary layer. In this instance, the first medium, which is adjacent to the channel surface, exhibits sheath flow.

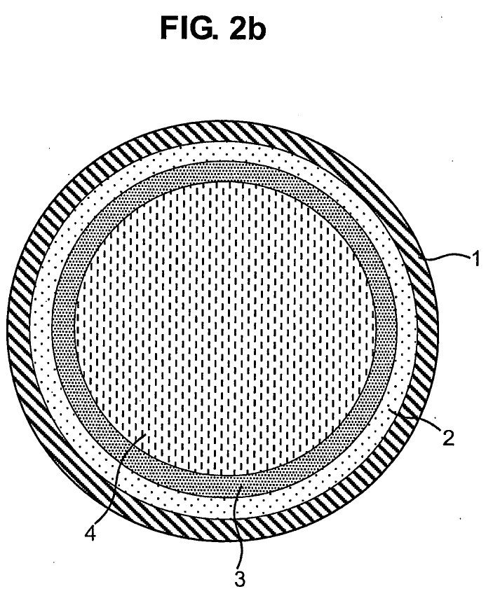

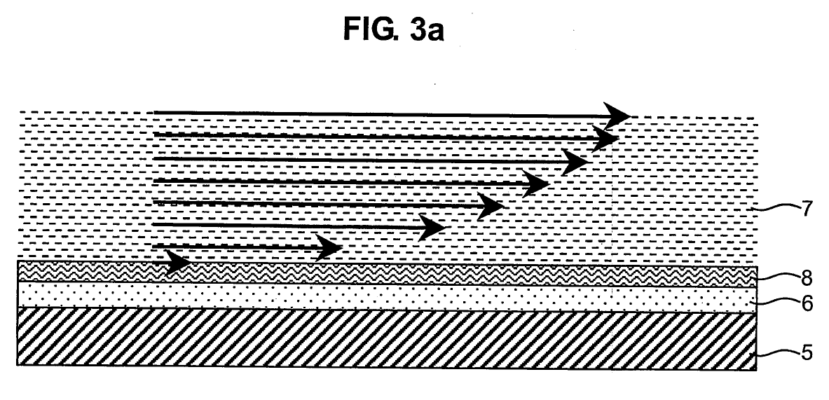

FIG. 2 depicts the proposed structure of four layers produced by treating a glass channel wall 1 to make it compatible with a perfluorinated solvent, in the presence of a perfluorinated solvent and an aqueous medium. The glass channel 1 has on its inner surface a fluorinated layer 2 that is covalently attached to the glass. The fluorinated layer 2 is compatible with a non-aqueous medium 3 that is immiscible with the aqueous medium 4 and has low affinity for the components of a biological assay. In alternative embodiments, the layer 2 may be a perflourinated polymer layer that is attached to 1 by adsorption and baking at high temperature, e.g. baking at temperatures above 150° C. of CYTOP (Registered Trademark, Asahi Glass Corporation).

FIG. 3a represents a parabolic flow profile of a comparative hydrodynamically pumped flowing system in the absence of the non-aqueous solvent phase. It illustrates how the microchannel surface 5 and fluorinated surface layer 6 remain static whilst the aqueous medium 7 flows across and is in contact with the channel surface. In this instance, there is a stationary layer 8 of the aqueous medium at the interface of the aqueous medium 7 and the fluorinated surface. Components of the aqueous medium in the stationary layer 8 are free to diffuse to and adsorb to the fluorinated surface, which is undesirable.

FIG. 3b illustrates a parabolic flow profile of a flowing system, according to the subject matter disclosed herein including a sheath medium. In this instance, the sheath medium 10 and the aqueous medium 11 flow in the same direction while the aqueous medium 11 does not contact and remains spaced from the fluorinated surface layer 12. There is no stationary layer present in the aqueous medium 11 when the sheath of non-aqueous medium 10 is between the aqueous medium and the glass surface. Instead a stationary layer 13 can be seen in the non-aqueous medium close to the channel surface. The absence of a stationary layer in the aqueous medium is likely to result in a decrease in the interactions that lead to adsorption of assay compounds to the glass surface.

FIG. 3c illustrates an embodiment similar to that of FIG. 3(b), with pseudo-parabolic flow profile of both media. This profile, due to hydrodynamic pumped flow, is distorted due to the different viscosities of the two media. In the instance when the non-aqueous medium 15 (e.g. perfluorodecalin) has a higher viscosity than the aqueous medium 16 it would be expected that the net flow velocity of aqueous medium 16 would be significantly higher than that of the non-aqueous medium 15. Therefore, the aqueous medium would effectively ‘slip’ across the interface with the non-aqueous medium as illustrated in FIG. 3c. As the non-aqueous medium layer 15 is flowing across the fluorinated surface 17 in the same direction as the aqueous medium 15, the aqueous medium is effectively passing over a mobile ‘self-regenerative’ interface relative to any static, predefined position in the microfluidic channel (e.g. the detection point).

The decrease in adsorption of components of the aqueous medium to the channel surface is, therefore, a product of the following factors:
1. the decreased adsorption of component by the surface due to presence of a fluorinated channel surface, particularly a perfluoroalkyl silane;
2. the presence of a non-aqueous medium, which has low adsoptive capacity for the components of the aqueous medium, between the aqueous medium and the channel surface; and
3. the absence of a stationary layer within the aqueous medium relative to a fixed position on inner channel surface.

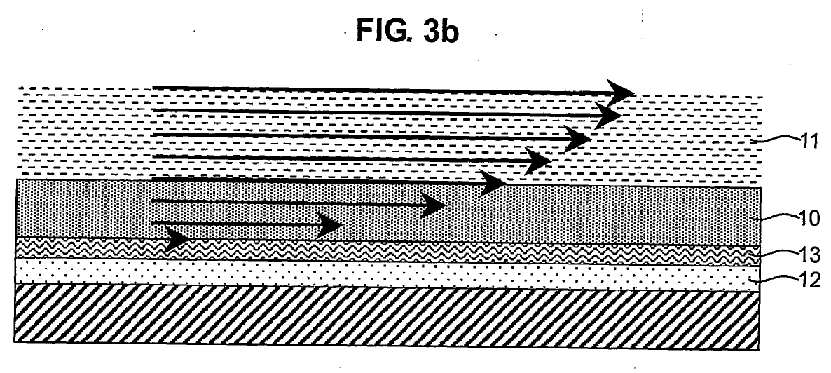

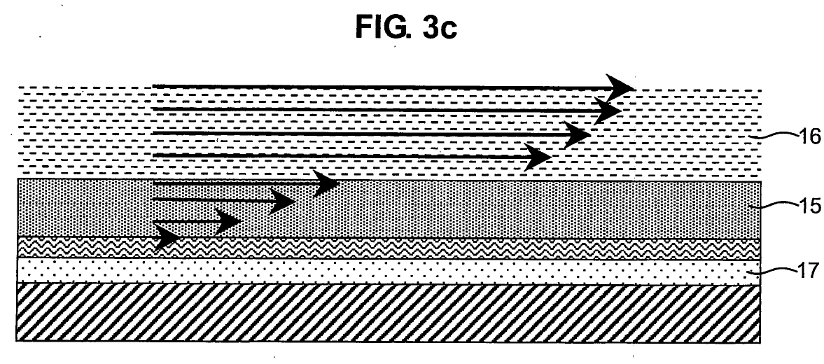

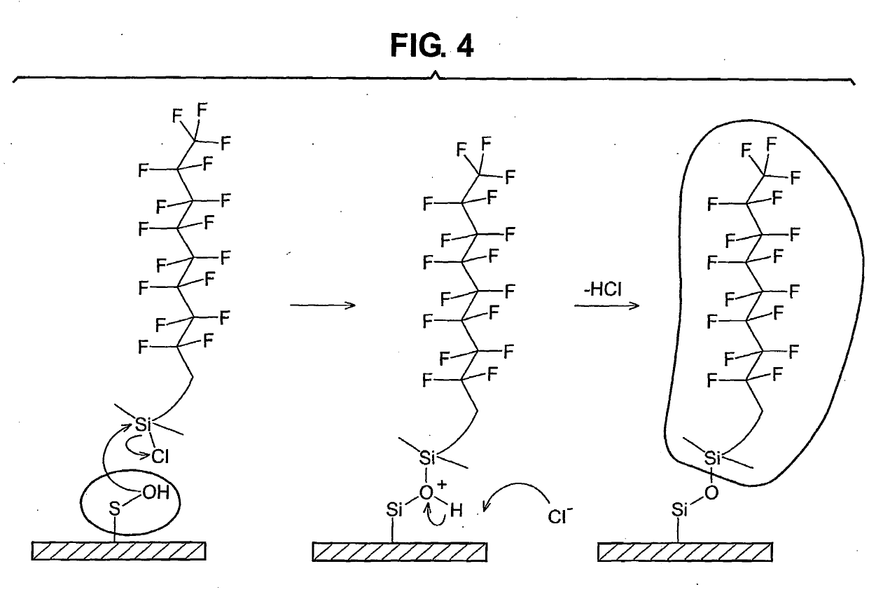

FIG. 4 shows a reaction scheme for the preparation of a channel for use in one embodiment of the subject matter disclosed herein, wherein the silanol groups SiOH of a glass surface of the channel wall are reacted with a perfluoroalkylsilane, namely 1H, 1H, 2H, 2H-perfluorodecyidimethylchlorosilane. In this instance, the reaction is self-limiting, and produces a homogenous pseudomonolayer of perfluoroalkyl substituents. The homogenous thin layer allows polarisation of light to be maintained. Therefore, fluorescence polarisation, which is a commonly used detection technique for performing biological assays, can be used.

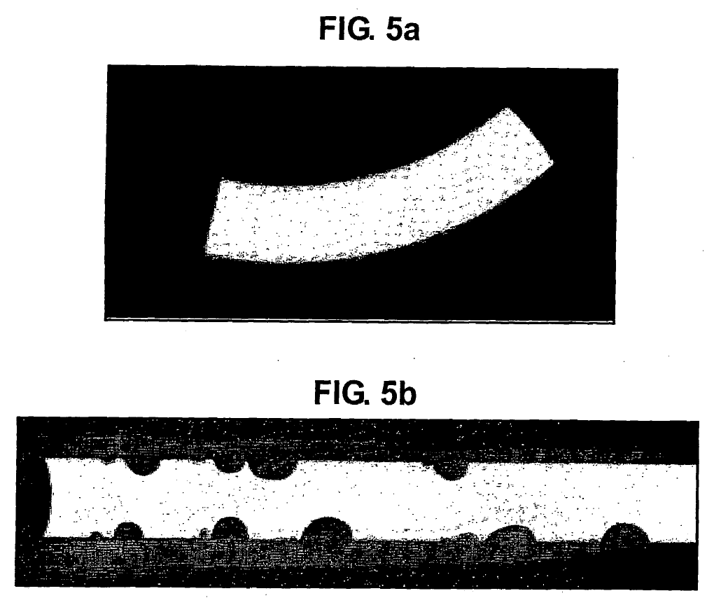

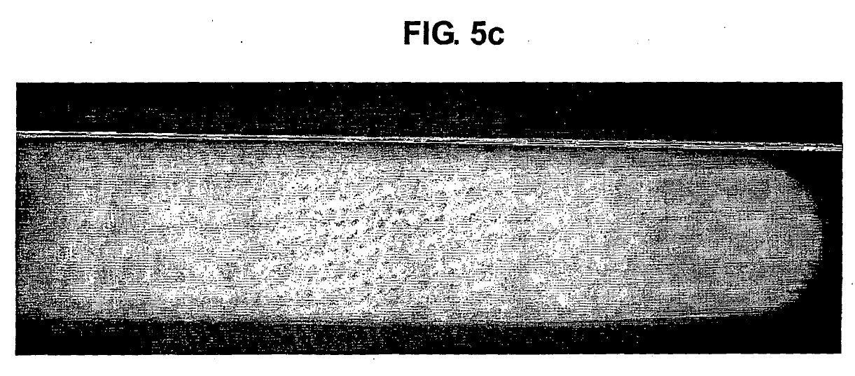

FIGS. 5a and 5c illustrate an encapsulation effect in which the non-aqueous medium, perfluorodecalin, and the aqueous medium, which is doped with the fluorescent dye fluorescein, are pumped through a glass microchannel, the interior surface of which has been treated with 1H, 1H, 2H, 2H-perfluorodecydimethylchlorosilane (FIG. 5a), or coated with CYTOP™ (FIG. 5c). Fluorescence imaging and videomicrography (not illustrated) demonstrate that the aqueous medium remains spaced from the channel surface by a sheath of the non-aqueous medium, which in this case is perfluorodecalin. The thickness of the non-aqueous sheath is estimated to be between 1 μm and 2 μm.

In FIG. 5b the higher affinity of the non-aqueous medium for channel surface results in the formation of droplets of non-aqueous medium on the surface of channel. This droplet formation may be due to incomplete or irregular coating of the channel by the fluorinating agent.

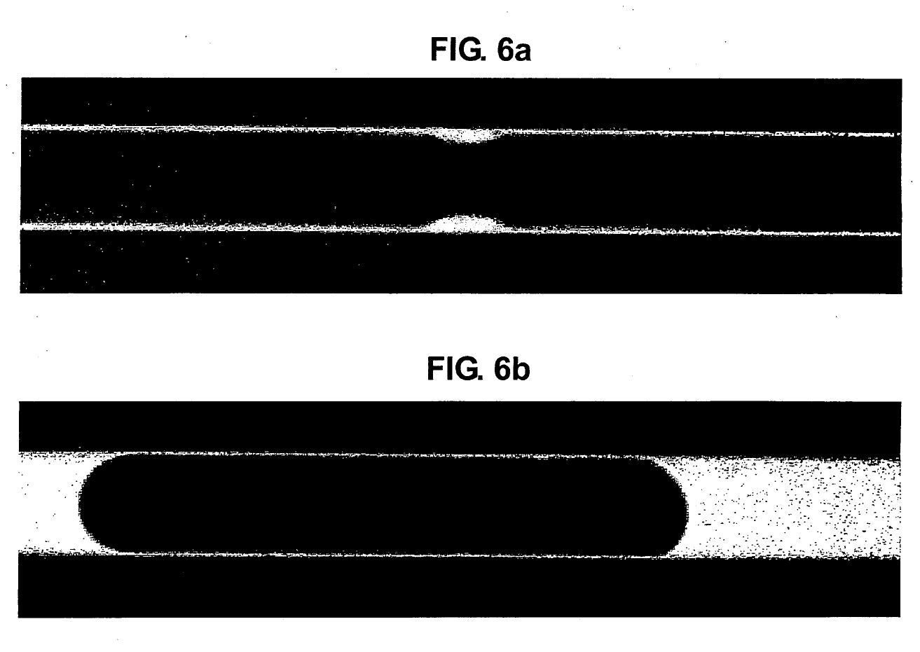

FIG. 6 shows a comparative fluorescence micrograph of a glass channel which has not been derivatized with 1H, 1H, 2H, 2H-perfluorodecyldimethylchlorosilane. Therefore the predominant chemical group of the channel surface is silanol. The aqueous medium containing fluorescein coats the surface in preference to non-aqueous medium such that non-aqueous medium remains spaced from the surface, is encapsulated by the aqueous medium and forms a droplet i.e. the reverse of FIG. 5. In effect, molecules within the aqueous medium in the embodiment of FIG. 6 are free to interact with the surface.

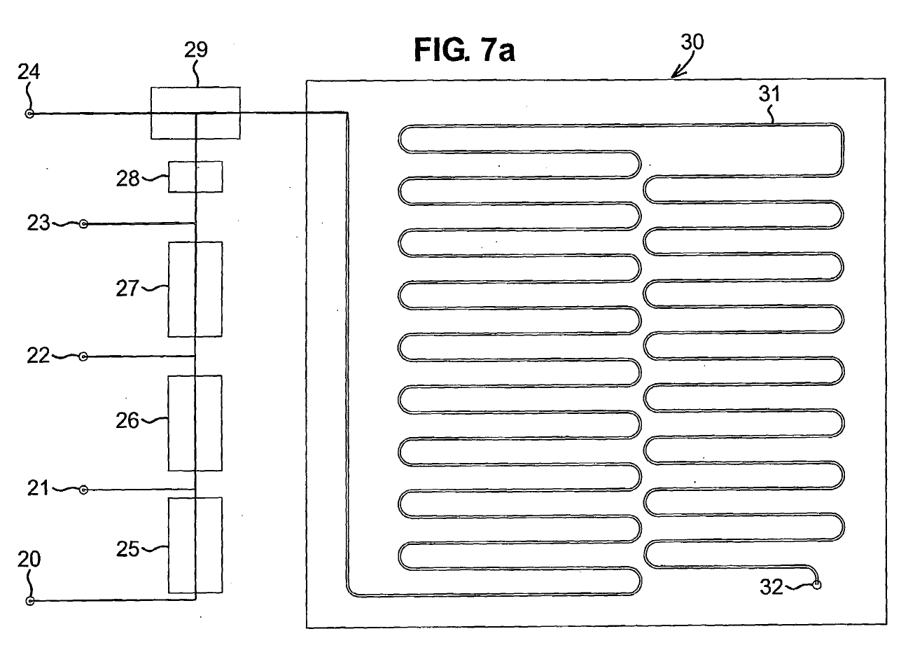

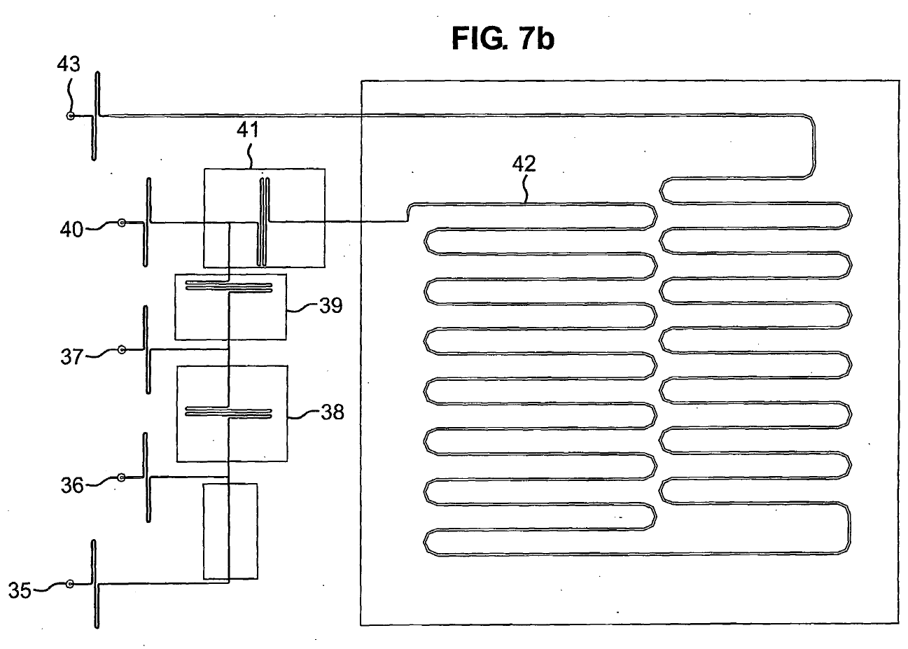

Referring to FIG. 7a, the microfluidic system comprises four major functional areas:
1. reagent and non-aqueous medium introduction ports 20,21,22,23 and 24 respectively;
2. reagent mixing areas 25, 26, 27, 28;
3. mixing area of reagents with non-aqueous medium at 29 such that the non-aqueous medium produces a sheath layer around the pre-mixed reagents; and
4. an incubation and detection area 30.

The reagents are mixed in a pre-defined sequence with pre-defined mixing equilibration times in the pre-incubation mixing areas 25, 26, 27, 28. Mixing of the assay components occurs under laminar flow conditions and is dependent on the diffusion coefficients of the components of the aqueous medium. The microscopic confines of 25 to 28 (typically 10-100 μm) allow mixing to near equilibrium to occur very quickly at 37° C. The temperature at which the microchannel device is typically used. Mixing of the aqueous medium with the non-aqueous medium, which in the case of this illustration is perfluorodecalin (PFD) supplied through port 24, occurs within the area 29. The angle of the intersection in this illustration is 90° or a T-shape but it can be any angle between 20° and 160°. Incubation of the biphasic flow produced by the aqueous medium and the non-aqueous medium prior to time-dependent measurement/detection occurs within serpentine channel 31 in incubation and detection chamber 30. The incubation time is determined by the flow-rate and the internal dimensions of the microchannel that constitutes the incubation and detection chamber, but the microchannel of the incubation and detection chamber typically has a cross-sectional dimension that is two to ten greater than that of the preceding channels by two- to four-fold. The flow exits the microfluidic device through outlet 31 or to an additional external detection system, such as a mass spectrometer.

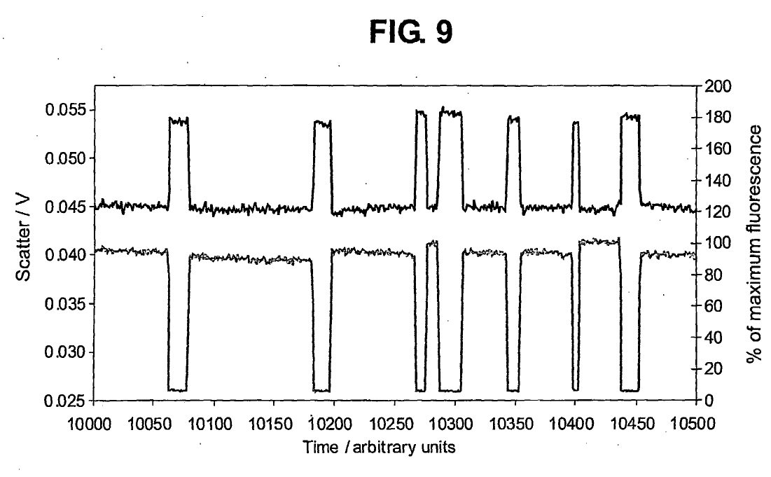

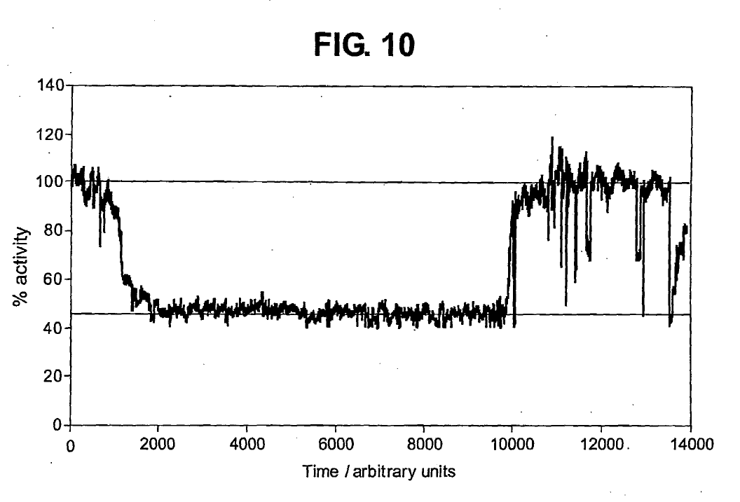

FIG. 7(b) shows a device similar to that of FIG. 7(a), except that there are only three reagent introductions ports 35, 36, 37 and two mixing regions 38,39. There is also an inlet 40 for the fluorinated solvent. The fourth mixing area 41 corresponds to the mixing area of the reagents with the non-aqueous medium. The serpentine reaction channel 42 leads to outlet 43 as before. This embodiment was used to produce the data shown in FIGS. 9 and 10.

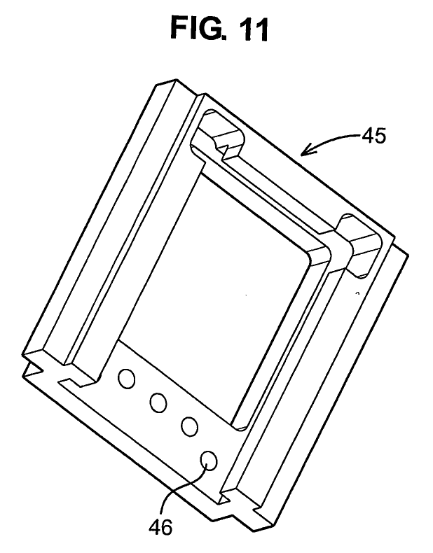

The microfluidic chips of FIGS. 7(a) and 7(b) are mounted in the customized chip holder 45 of FIG. 11, which is provided with inlet apertures such as aperture 46 in register with the reagent and solvent introduction ports on the chip.

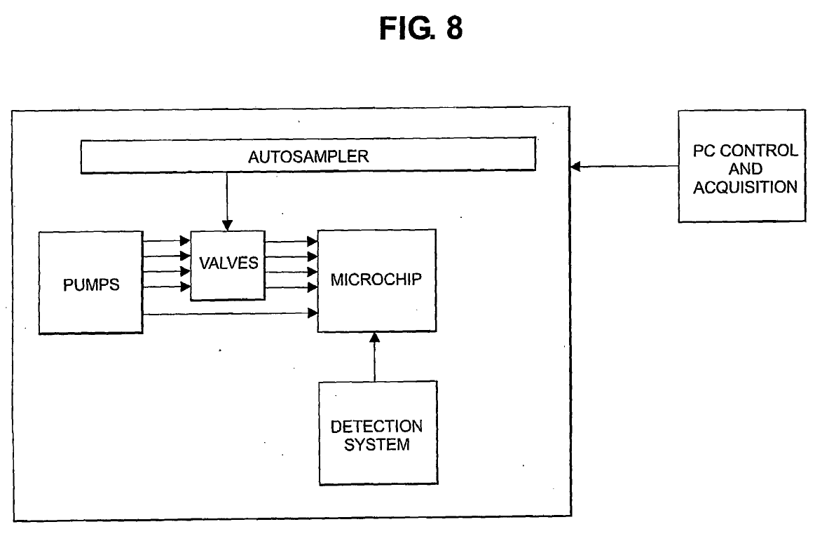

FIG. 8 illustrates an instrument scheme according to the subject matter disclosed herein. The introduction of samples for analysis is automated using a syringe-based autosampler and associated fluidic valves that have inner volumes (less than 25 nL) of similar magnitude to those of the microfluidic channels. Sample fluids are pumped from the valves to the microfluidic chip (MICROCHIP) using four pumps. A fifth pump pumps the non-aqueous medium directly to the microfluidic chip. The ‘default’ solvent for the pumping system is the non-aqueous medium. The required volume of aqueous medium is introduced into the system using the valves described above.

The presence of the non-aqueous medium ahead and behind the assay components in. the channel or the tubing linking the valves to the microchannel allows the tubing to be ‘regenerated’ between the successive introduction of reagents. The surface of all the tubing of the system is treated identically to that of the microchannel.

Optical changes that occur within the microchannels of the microchip are monitored using the detection system. The whole system is under the control of a microcomputer driven control and data acquisition program.

FIG. 9 shows the inverse relationship between the measured backscattered light (BSL) and emitted fluorescence light (EFL) in an embodiment wherein the non-aqueous medium is perfluorodecalin.

### EXAMPLE

### Coating Of The Glass Microchannel Surface

For dervatization of the internal surface of the glass microchannels, glass microchannels (Micronit microfluidics bv) were coupled up to syringes (volume 100 uL, model 81075, Hamilton company) via polyimide-coated fused silica capillaries (Polymicro Technologies) with outer diameter of 375 urn and internal diameter of 100 um. Capillaries were connected to the syringe needle via an in-line, Microtight (Registered Trade Mark) capillary connector (Upchurch scientific) and were connected to the glass microchannel chip via a bespoke connector block (FIG. 11) using Nanoport (Registered Trade Mark) connector adaptors (Upchurch Scientific). Fluid was pumped using stepper motor-based syringe pumps (model 33, Harvard Apparatus Company).

In one embodiment, the internal surface of glass microchannels (Micronit Microfluidics bv), which had internal dimensions of 20 um depth and 50 um, 70 um and 120 um width, were derivatized with 1H, 1H, 2H, 2H-perfluorodecyldimethylchlorosilane using the following protocol. All steps were performed at 80° C. with reagents flowing throughout the device continuously. The first step, termed “pre-treatment”, comprised the flow of purified water at 1 μl per minute for 20 minutes followed by dry methanol at 1 μL per minute for 20 minutes, followed by dry toluene at 1 μL per minute for 20 minutes. The second step, termed silanisation treatment consisted of pumping 10% (v/v) 1H, 1H, 2H, 2H-perfluorodecyldimethylchlorosilane in dry toluene at 500 nL per minute for 60 minutes. The third step, termed “post-treatment”, comprised of pumping dry toluene at 1 μL per minute for 20 minutes, followed by dry methanol at 1 μL per minute for 20 minutes, followed by nitrogen gas at 1 μL per minute for 20 minutes.

In an alternative embodiment, the internal surface of glass microchannels were coated with CYTOP (Registered Trade Mark) using the following protocol. All steps were performed with reagents flowing throughout the device continuously. The first step, termed “pre-treatment”, comprised dry methanol at 1 μL per minute for 20 minutes at 23° C., followed by dry toluene at 1 μL per minute for 20 minutes at 23° C., followed by nitrogen gas at 1 μL per minute for 20 minutes at 23° C. The second step, termed “CYTOP treatment”, comprised 10% (v/v) CYTOP CTL-107M in CTL-SOLV [Asahi Glass Corporation] solvent at 1 μL per minute for 20 minutes at 23° C., followed by nitrogen gas for 5 minutes to leave a thin film of CYTOP on the channel surface, followed by evaporation of remaining solvent for 90 seconds by placing the chip directly on a hot plate at 100° C., followed by heating at 200° C. for 60 minutes to “anneal” or bond the CYTOP to the glass surface. The third step, termed “post-treatment” comprised dry toluene at 1 μL per minute for 20 minutes, followed by dry methanol at 1 μL per minute for 20 minutes, followed by Nitrogen gas at 1 μl/min for 20 minutes.

Glass microchannel devices treated using either one of the protocols described above were termed “fluorinated glass microchannel devices”.

### Imaging Of Dynamic Mobile Wall

The presence of the dynamic mobile wall was demonstrated by pumping fluorescein in buffer and a fluorinated solvent through the glass microchannel device simultaneously whilst imaging the fluorescence of fluorescein by fluorescence microscopy. Fluorescence microscopy was performed using an inverted fluorescence microscope (Model TE2000U, Nikon UK Ltd) equipped with a 488 nm excitation filter, 500 nm dichroic filter and 530 nm emission filter. Images were recorded using a three colour COD camera (model XC-003P, Hamamatsu Photonics (UK) Ltd) and Image-Pro Plus (Media Cybernetics UK Ltd).

Fluorinated glass microchannel devices were typically coupled up to syringes (500 nl volume model 81265, Hamilton Company) via polyimide-coated fused silica capillaries (Polymicro Technologies) with outer diameter of 375 um and internal diameter of 100 um. Capillaries were connected to the syringe needle via a capillary microtight connector (Upchurch scientific) and were connected to the glass microchannel chip via a bespoke connector block (FIG. 11) using Nanoport connector adaptors (Upchurch Scientific). Fluid was pumped using stepper motor-based syringe pumps (model 33, Harvard Apparatus Company).

To fill the fluorinated glass microchannel device, perfluorodecalin and fluorescein (15 uM ) in HEPES buffer (50 mM, pH 7.4) were each pumped in to the chip simultaneously at 1 uL per minute. When the devices were full, the volumetric flow-rates were decreased to 0.1 μL per minute for the perfluorodecalin and 0.05 μl/min for the fluorescein until the two immisable solvents were visible within the microchannels. Flow was then stopped and images were acquired. One side surface of the microchannel was visualised using non-fluorescence-derived, surface scattered light of identical wavelength to the emission filter used in the microscope from oblique illumination with white light from above. White light was provided using a fibre-coupled light source (model KL1500 LCD, Schott AG).

The effect of coating the surface either by derivatization with 1H,1H,2H,2H-perfluorodecyldimethylchlorosilane or adsorption with CYTOP was demonstrated clearly in FIGS. 5a, 5b, 5c, 6a and 6b. In the absence of a fluorinated surface the aqueous fluorescein medium associates with the surface whilst the perfluorodecalin remains separated from the surface by a layer of aqueous medium (FIG. 6). In the case of a fluorinated glass microchannel surface, the aqueous fluorescein medium does not appear to associate with the surface, whilst the perfluorodecalin appears to preferentially associate with the surface (FIGS. 5a and 5b). Using oblique surface illumination with white liqht, the fluorescein aqueous layer appears to be separated from the fluorinated surface (FIG. 5c). Therefore, in the fluorinated glass microchannel device, the perfluorodecalin acts as a dynamic mobile wall maintaining the aqueous medium separate from the microchannel surface. In this case, neither the aqueous medium nor reagents or drug-like compounds within the aqueous medium would be able to adsorb to the surface by virtue that the are unable to come in contact with the surface.

### Use Of Fluorinated Glass Microchannel Devices For Performing Microfluidic Biological Assays.

A fluorescence resonance energy transfer (FRET) assay provides an example of a way in which the subject matter disclosed herein may be used in conjunction with an Fl technique. FRET is suitable for, for example, inhibition studies of proteases. It may, for example, be used for matrix metalloproteinase 12 (MMP-12) studies. A system for measuring fluorescence intensity (Fl) may be used in conjunction with the subject matter disclosed herein. In particular, the following experimental set-up has been used.

The microbiochemistry Fl assay platform (FIG. 8) was used for pumping reagents, introduction of reagents in to the fluorinated glass microchannel device and continuous detection of Fl. A flowing compound system was used, which comprised the following components: a four channel nano-flow pump (Eksigent Technologies) that was used to pump perfluorodecalin in four independently controlled flowing streams at between 5 and 500 nl/min per channel; an autosampler to introduce reagent or inhibitor/activator [HTS PAL with Cycle Composer software, CTC Analytics AG] into the system via four nano-volume steel valves [C2N-4306D, Vici]; x,y,z-positioning stage and motors [components from Physik (PI) Instrumente-Polytek Group] to locate the point of detection at the centre of a microfluidic channel, which was within the fluorinated glass microchannel device [Micronit Microfluidics bV]; an incubator to house the microchannel device [Linkam Scientific Instruments Ltd] which was maintained at 37° C. using a temperature controller [INC37, Linkam Scientific Instruments Ltd]; capillary conduits between the pump/microchannel device and the valves were pre-cut and polished fused silica capillaries [Polymicro Technologies] of 30 μm internal diameter and 375 μm outer diameter; and each valve also has a capillary loop acting as a reagent reservoir. The use of micro-bore capillaries and nano-volume valves enabled low dead volumes and fast transit times from the valves to the microchannel device. The Fl measurement system [Genapta Ltd, WO-A-03048744] involved excitation of fluorophore, by a diode-pumped solid state laser with an excitation wavelength of 488 nm (model Sapphire 488-20, Coherent Inc.). Detection was facilitated by a confocal optical head at an emission wavelength of 530 nm with an analogue photomultiplier tube (PMT). The scatter signal was provided for using a separate diode laser at 635 nm and measuring the back-scattered light at 635 nm using a PIN diode (Genapta Ltd). The laser and the PMT were coupled to the optical head using optical fibres. The Fl and scatter data were acquired from the PMT using an analogue PCI-6115S card [National Instruments] controlled by software written using LabView 7 Express [National Instruments]. Between 100 and 1000 data points were collected per second, each data point was the average of 50 samples and acquisition data was synchronised between fluorescence and scatter channels. Since the presence of fluorescein in the aqueous medium produced a high fluorescence signal specific to the aqueous medium, data acquired in the fluorescence acquisition channel as the aqueous medium passed the detection point could be “gated” using software (as opposed to electronically) from data acquired in the same channel as the perfluorodecalin passed the point of detection using a simple “peak-picking”algorithm (National Instruments) that could be performed after all the data had been acquired and stored.

The Fl system has been successfully used in accordance with the subject matter disclosed herein to measure the fluorescence the fluorescein aqueous medium and discriminate from the non-fluorescent perfluorodecalin medium, and perform an assay for matrix metalloproteinase 12 (MMP12), Specifically, a fluorescence resonance energy transfer (FRET) assay for MMP12 inhibitors was used.

Using a fluorinated glass microchannel device, specifically one treated with 1H, 1H, 2H, 2H-perfluorodecyidimethylchlorosilane, fluorescein (100 nM in 50 mM HEPES buffer, pH 7.4) and buffer (50 mM -HEPES, pH 7.4) were introduced, via two valves in to two of the four channels, whilst perfluorodecalin was pumped through the remaining two channels. Fluorescence data and back-scatter were acquired simultaneously as described above. There was an inverse correlation between the backscaftered signal, due to difference in refractive index/back-scatter between aqueous medium and perfluorodecalin, and the fluorescence signal (FIG. 9). In the presence of aqueous medium the fluorescence signal was high, due to the presence of fluorescein, and the back-scatter signal was low, whereas in the presence of perfluorodecalin the fluorescence signal was low and the back-scatter signal was high.

MMP12 cleaves a substrate peptide, labelled with both a carboxyfluorescein (FAM) donor fluorophore and a tetramethylrhodamine (TAMRA) acceptor fluorophore, liberating the donor fluorophore with a resulting increase in fluorescence. The assay involved human, recombinant MMP12 catalytic domain (residues G106-N268) expressed in E coli and FAM-TAMRA labelled substrate peptide [fam-Gly-Pro-Leu-Gly-Leu-Phe-Ala-Arg-Lys-TAMRA-NH₂ synthesised in-house. The substrate and enzyme were prepared to the required concentrations in assay buffer: 50 mM HEPES (N-(2-Hydroxyethyl)piperazine-N′-(2-ethanesulfonic acid)) (pH 7.4), 150 mM NaCl, 10 mM CaCl₂, 1 μM zinc acetate, 0.2% (v/v) Tween 80 (polyethylenesorbitan monooleate), 0.02% (w/v) sodium azide in MilliQ purified water (all buffer reagents were from Sigma, except HEPES, which was from Invitrogen]. 2% (w/v) lithium dodecyl sulfate (LDS) [from Sigma] was used to clean the injection syringe after substrate and enzyme injection. 2% (w/v) LDS was also used to clean the microchannel device as required. Inhibition of MMP12 was demonstrated using a small molecule inhibitor, known to have an inhibition constant (K_{I}) of approximately 290 nM from a microplate-based MMP12 assay. The inhibitor was diluted in to assay buffer from a 10 mM stock, prepared in neat dimethylsulfoxide (DMSO), to the required concentration.

Initially the pump continually flowed perfluorodecalin, which constituted the mobile phase for the assay system, through all four channels. The reagents (MMP-12 and labelled substrate) and inhibitor were then introduced into the system, replacing the mobile phase. The total flow rate in the system was maintained at 400 nl/min. The reaction was performed at 37° C. Prior to injection, the enzyme, substrate and inhibitor were stored at 4° C. in glass vials in a cooled tray on the CTC Analytics HTS Pal autosampler. 4 M substrate peptide was injected into one channel flowing at 100 nl/min. The injection syringe was then cleaned in 2% (w/v) LDS, stored in a room temperature CTC reagent reservoir, followed by 100% (v/v) methanol and finally water. 19 nM MMP-12 enzyme was injected into a second channel flowing at 100 nl/min and the syringe needle was cleaned as above. Enzyme buffer only was introduced into a third channel at 100 nl/min. The flow rate was increased in the substrate, enzyme and channels to 500 nl/min for 3 minutes to quickly equilibrate concentrations at the detection point. The final concentrations in the assay were: 1 uM substrate peptide, 4.8 nM MMP-12, 50 mM HEPES (pH 7.4), 150 mM NaCl, 10 mM CaCl₂, 1 μM zinc acetate, 0.02% Tween 80, 0.02% (w/v) sodium azide. Perfluorodecalin which acted as the sheath fluid for the dynamic mobile wall, was pumped through the fourth channel continuously. In the embodiment described, the enzyme, substrate, buffer and perfluorodecalin were mixed only once inside the device by intersection of the respective microchannels. The four fluidic components were mixed sequentially inside the microchannel device in the following sequence: buffer, enzyme, substrate followed by perfluorodecalin.

Once a stable enzyme-substrate (ES) signal was achieved as characterised by a high fluorescence signal due to cleavage of the peptide substrate by MMP-12 (EFL, FIG. 10), inhibitor was injected into the third channel and replaced the buffer that had been introduced previously. Inhibitor was pumped into the chip at 100 nL per minute. Inhibitor was removed from the system by switching the reservoir loop, that is present in the two position valve, out of the flow path such that inhibitor did not flow towards the fluorinated glass microchannel device. Fluorescence data was acquired continuously and stored. Fluorescence data that corresponded to the fluorescence of product produced due to cleavage of the substrate by MMP-12 was processed to “gate-out” data due to the presence of non-fluorescent perfluorodecalin using “peak-picking” processing software (written in-house using LABVIEW™, National Instruments). It was demonstrated that the presence of the inhibitor produced inhibition of MMP-12 activity, as characterised by the decrease in fluorescence, whilst removal of the inhibitor produced a rapid increase in fluorescence (FIG. 10). When the compound was infused Cᵢₙ into a microfluidic device there was a rapid decrease in EFL from maxima EFLₘₐₓ to minima EFLₘᵢₙ. When the compound was removed Cₒᵤₜ from the microfluidic device EFL returns to EFLₘₐₓ rapidly. The data demonstrates that adsorption of the compound to the surface was minimal. The rapid increase in fluorescence indicated that the inhibitor had been removed from the microfluidic device rapidly and indicated that the inhibitor did not adsorb to the surface of the microchannel surface to any significant extent.

The above example has been described by way of example only. Many other embodiments falling within the scope of the accompanying claims will be apparent to the skilled reader.

It will be understood that various details of the subject matter can be changed without departing from the scope of the subject matter. Furthermore, the foregoing description is for the purpose of illustration only, and not for the purpose of limitation.

1. A microfluidic system comprising:
at least one microfluidic channel, the inner surface of which is fluorinated or fluorous; and
a pump for supplying a flow of an aqueous medium containing chemical reagents or assay components to said microfluidic channel.

2. A microfluidic system comprising:
at least one microfluidic channel, the inner surface of which is fluorinated or fluorous; and
a supply of an aqueous medium containing chemical reagents or assay components to said microfluidic channel; and
a supply of a non-aqueous medium, which is compatible with the surface of the microfluidic channel but immiscible with the aqueous medium, to the microfluidic channel for forming a sheath around the flowing aqueous medium whereby the aqueous medium is suspended away from the surface of the microfluidic channel.

3. The microfluidic system of claim 1, further comprising at least one detector associated with a detection position in the channel for detecting a signal from said aqueous medium while the aqueous medium is in the channel and either static or flowing past the detection position.

4. The microfluidic system of claim 1, wherein the material in which the channel is formed is transparent or translucent.

5. The microfluidic system of claim 3, wherein, the channel is long enough and the one or more detectors are configured to allow time-based kinetic studies to be carried out.

6. The microfluidic system of claim 1, wherein the channel is located in a microfluidic chip, optionally comprising a plurality of microfluidic channels, each of which has a fluorinated or fluorous inner surface.

7. The microfluidic system of claim 6, wherein the chip has an overall area of at most 400 mm².

8. The microfluidic system of claim 1, wherein, the microfluidic channels have a cross-sectional dimension of from about 1 mm to less than 1 mm, depth dimension from 5 mm to 100 mm and a length of from 0.1 m to 1 m.

9. The microfluidic system of claim 1, wherein the system comprises a plurality of said channels, and the channels are interconnected such that a plurality of reagents or assay components may be introduced into separate channels and flow into a single channel wherein the reaction of all the components takes place.

10. The microfluidic system of claim 1, wherein some and preferably all of the surfaces of the following parts of the system are fluorinated or fluorous: channels, tubes, connectors, valves, and conduits used to transport reagents or components of the assay system or the non-aqueous medium to a microfluidic chip.

11. The microfluidic system of claim 1 comprising at least one valve, wherein any valve used in the microfluidic system has a tubing inter-connection volume of at most about 25 nL.

12. The microfluidic system of claim 1, wherein the channel has been formed from a non-fluorinated substrate material that has been surface treated with a fluorinated/fluorous finish or a fluoropolymer coating to fluorinate said inner surface.

13. The microfluidic system of claim 12 wherein the channel has been treated with a perfluorinated finish selected from the group consisting of fluorinated silanes, such as a perfluoroalkylsilane, long chain alkysilanes, such as hexyl or octyl silane, or mono- and di-chlorinated silanes, such as decyldichlorosilane.

14. The microfluidic system of claim 1, wherein the channel has been formed from a fluorinated substrate material.

15. The microfluidic system of claim 14, wherein the fluorinated substrate material is selected from the group consisting of perfluoropolymers, such as polytetrafluoroethylene (PTFE) or perfluoroalkoxy (PFA) copolymer.

16-27. (canceled)

28. A method for carrying out a chemical reaction or a biological assay in a microfluidic system which comprises:
causing a first medium containing the reagents or the assay components to flow through a microfluidic channel of the microfluidic system; and
causing a second medium, which is immiscible with the first medium, to flow through the microfluidic channel whereby the second medium forms a sheath around the flowing first medium.

29. The method of claim 28, wherein the microfluidic system is a system as defined in claim 1.

30. The method of claim 28, wherein the first medium is an aqueous medium and the second medium is a non-aqueous medium, for instance a fluorous medium.

31. The method of claim 28, wherein the flow rate in the channel is at most 2 μL/min.

32. The method of claim 28, wherein a constant flow of the second medium is supplied, into which are introduced discrete aliquots of the first medium so that, if desired, different quantities of one or more of the components of the chemical reaction or the assay may be present in different aliquots of the first medium.

33-37. (canceled)
